(19) United States
(12) Patent Application Publication
(10) Pub. No.: US 2013/0219278 A1
(43) Pub. Date: Aug. 22, 2013

(54) Transferring of Communication Event

(71) Applicant: Jonathan Rosenberg, Freehold, NJ (US)

(72) Inventor: Jonathan Rosenberg, Freehold, NJ (US)

(21) Appl. No.: 13/400,418

(22) Filed: Feb. 20, 2012

(51) Int. Cl. G06F 3/01

(52) U.S. Cl. 715/733

(57) ABSTRACT

A method and system for transferring a communication event between a remote user device and a first user device from the first user device to a second, alternate user device is described. The method comprises capturing with a visual motion recognition component a first input from a user of the first user device conducting the communication event, the first input being a physical gesture made by a user to indicate a desire to transfer the communication event. A set of user devices in physical proximity to the user is detected, and a second physical gesture made by the user is captured to select one of the set of devices. The communication event is then transferred to the selected device.

### TECHNICAL FIELD

The present invention relates to a communication system and a corresponding method for transferring voice and/or video calls between user devices or terminals.

### BACKGROUND

Communication systems exist which allow a live voice and/or video call to be conducted between two or more end-user terminals over a packet-based network such as the Internet, using a packet-based protocol such as internet protocol (IP). This type of communication is sometimes referred to as “voice over IP” (VoIP) or “video over IP”.

To use the communication system, each end user first installs a client application onto a memory of his or her user terminal such that the client application is arranged for execution on a processor of that terminal. To establish a call, one user (the caller) indicates a username of at least one other user (the callee) to the client application. When executed the client application can then control its respective terminal to access a database mapping usernames to IP addresses, and thus uses the indicated username to look up the IP address of the callee. The database may be implemented using either a server or a peer-to-peer (P2P) distributed database, or a combination of the two. Once the caller's client has retrieved the callee's IP address, it can then use the IP address to request establishment of a live voice and/or video stream between the caller and callee terminals via the Internet or other such packet-based network, thus establishing a call.

However, with the increasing prevalence of electronic devices capable of executing communication software, both around the home and in portable devices on the move, then it is possible that the same end user may have multiple instances of the same client application installed on different terminals.

When a user is conducting a call using a user device, he sometimes desires to transfer the call to an alternate user device. For example, if he is conducting a voice over IP (VoIP) call via the Internet, using his personal computer (PC), he may wish to transfer the call to a mobile device to allow him to leave the location where his PC is fixed. Alternatively, if a video call is being conducted, he may want to transfer the call from a user device with a small screen to a user device with a larger screen. At present, it is possible to transfer calls between devices, but it requires a user to interact with a menu on the device to select an alternate device and then transfer the call. Such menus can be confusing, so that today transferring of calls between devices is a complex process which often confuses users and frequently results in dropped calls. Furthermore, the problem is getting more complicated as users have an increasing number of devices (mobile phones, televisions, soft phone applications, etc.) and increasingly complex call scenarios (video, video and sharing, etc.). At present, very few attempts have been made to address the complexities arising from these situations.

### SUMMARY

According to an aspect of the present invention, there is provided a method for transferring a communication event between a remote user device and a first user device from the first user device to a second user device, comprising capturing with a visual motion recognition component a first input from a user of the first user device conducting the communication event, the first input being a physical gesture made by the user to indicate a desire to transfer the communication event; detecting a set of user devices in physical proximity to the user; capturing a second input from the user to select one of the set of devices as a second device, the second input being a second physical gesture made by the user; and transferring the communication event to the second device.

A further aspect of the invention provides a user device for conducting a communication event with a remote user device, the user device comprising a visual motion recognition component configured to capture first and second inputs from a user of the user device, the first input being a first physical gesture made by the user to indicate a desire to transfer the communication event; and the second input being a second physical gesture; means for detecting a set of user devices in physical proximity to the users; wherein the second input from the user selects one of the set of devices as a second device; and means for transferring the communication event to the second device.

For a better understanding of the present invention and to show how the same may be carried into effect, reference will now be made by way of example to the following drawings.

### BRIEF DESCRIPTION OF THE DRAWINGS

FIG. 1 is a schematic diagram of a communication system;

FIG. 2 is a schematic diagram of a communication system in one particular context;

FIG. 3 shows calls being transferred; and

FIG. 4 is a block diagram of a user device.

### DETAILED DESCRIPTION

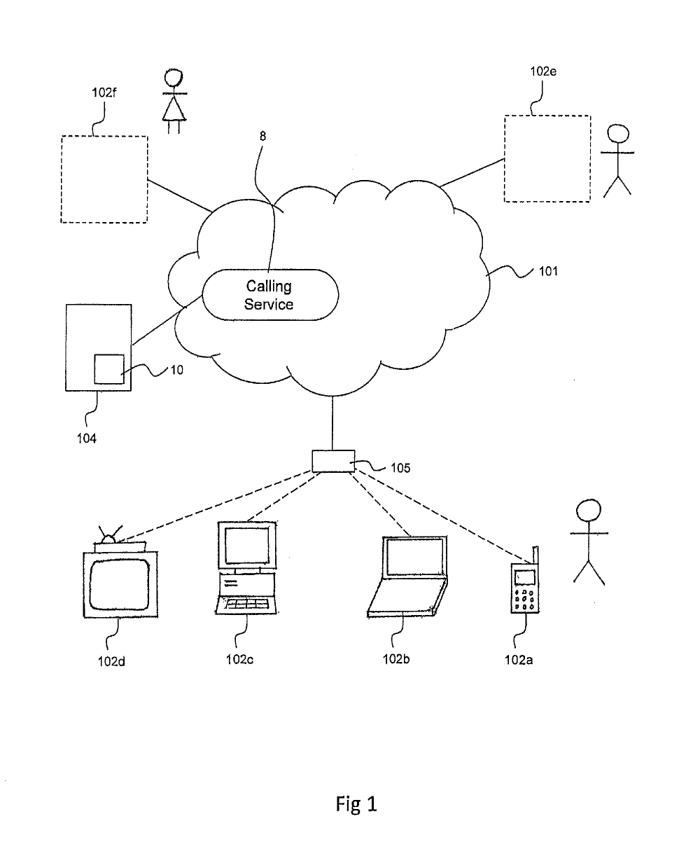

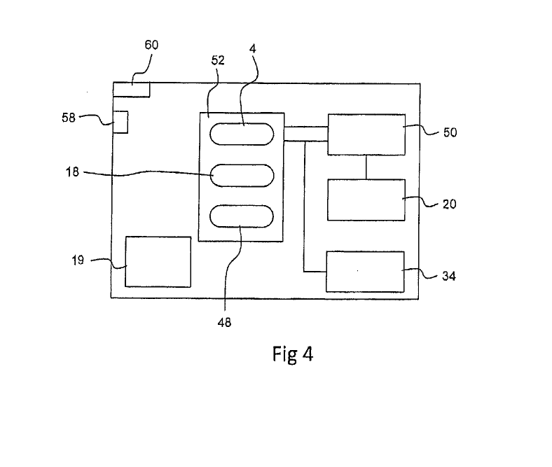

FIG. 1 is a schematic diagram of a communication system implemented over a packet-based network such as the Internet 101. The communication system comprises respective end-user devices 102a . . . 102g for each of a plurality of users. The devices are connected to or communicable with the Internet 101 via a suitable transceiver such as a wired or wireless modem. Each terminal 102 is installed with an instance of a client application 4 (shown in FIG. 4) for accessing the communication system and thereby establishing a live packet-based voice or video call with the client of another user running on another such terminal 102.

In the illustrative embodiment of FIG. 1 one user can be associated with multiple devices: a mobile handset type terminal 102a such as a mobile phone, a laptop computer 102b, a desktop computer 102c, and a television set or television with set-top box 102d. Other types of terminal 102 that may be installed with a communication client include photo frames, tablets, car audio systems, printers, home control systems, cameras, or other such household appliances or end-user devices, etc. Each of the multiple terminals 102a-102d of the same user is installed with a respective instance of the communication client application which the same user may be logged into concurrently, i.e. so the same user may be logged into multiple instances of the same client application on two or more different terminals 102a-102d simultaneously. This will be discussed in more detail below.

Each of the different end-user terminals 102a-102d of the same user may be provided with individual connections to the internet 101 and packet-based communication system, and/or some or all of those different terminals 102a-102d may connect via a common router 105 and thus form a local network such as a household network. Either way, it is envisaged that in certain preferred embodiments some or all of the different terminals 102a-102d of the same user may be located at different points around the house, e.g. with the television 102d in the living room, the desktop 102c in the study, the laptop 102b open in the kitchen, and the handheld 102a at any other location the user may happen to find themselves (e.g. garden or WC).

Also shown connected to the internet 101 is a data store 104 in the form of either a server, a distributed peer-to-peer database, or a combination of the two. The data store 104 forms part of a calling service 8 which provides an infrastructure for supporting communication events. A peer-to-peer database is distributed amongst a plurality of end-user terminals of a plurality of different users, typically including one or more users who are not actually participants of the call. However, this is not the only option and a central server can be used as an alternative or in addition. The calling service 8 can be any service capable of conducting communication events by the communication clients. One such service is Skype, which is a peer to peer service wherein the calling service issues authentication certificates to legitimate users, and wherein communication events between users are authenticated based on the authentication certificate. An authentication procedure is typically also required, which may involve the user providing credentials via the client to be centrally authenticated by a server, and/or may involve the exchange of authentication certificates between the two or more users' client applications according to a P2P type authentication scheme. Either way, the data store 104 is connected so as to be accessible via the internet 101 to each of the client applications or instances of client applications running on each of the terminals 102 of each user's communication apparatus 103. The data store 104 is arranged to provide a mapping of usernames to IP addresses (or other such network addresses) so as to allow the client applications of different users to establish communication channels with one another over the Internet 101 (or other packet-based network) for the purpose of establishing voice or video calls, or indeed other types of communication such as instant messaging (IM) or voicemail.

The communication client 4 has a log in/registration facility which associates the mobile device 102 loaded with the client with a particular user. A user can have instances of the same communication client running on other devices associated with the same log in/registration details.

In the case where the same user can be simultaneously logged in to multiple instances of the same client application on different terminals 102a-102d, in embodiments the data store 104 may be arranged to map the same username (user ID) to all of those multiple instances but also to map a separate sub-identifier (sub-ID) to each particular individual instance. Thus the communication system is capable of distinguishing between the different instances whilst still maintaining a consistent identity for the user within the communication system.

Embodiments of the present invention are directed to a scenario where a user may want to transfer a call to an alternate device that he can see is physically proximate to him.

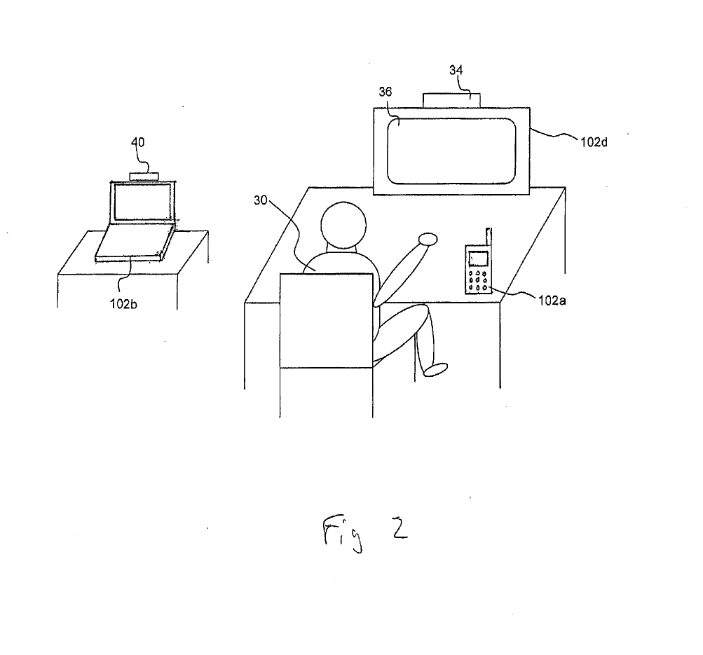

The call transfer method uses a technique referred to herein as “grab and throw”. According to this technique, the user utilises a mid-air grab gesture to indicate his desire to transfer the call, and then a throw gesture to place the call. For this technique to work, the device on which the call exists must have a connected camera and run gesture capture algorithms 42 (described later). An example scenario is illustrated in FIG. 2. A user 30 is seated in front of a television 102d installed with a camera 34. The television 102d has a screen 36 currently rendering a video call for example. User also owns a laptop device 102b installed with a camera 40, which in this case is also in the room proximate to the user. Although a laptop is shown, it will be appreciated that any suitable device could be present, e.g. a tablet or mobile phone 102a. All devices run a communication client 4 similarly to the scenario of FIG. 1. Instances of a communication client 4 are in contact with the calling service 8 and have log-in/registrations for the same user, also in common with the scenario at FIG. 1. In addition, the devices run gesture capture algorithms 42 which use data received from the respective camera 34, 40 to actively look for the grab gesture by the user when the user is on a call. When either camera detects this gesture, the call is considered grabbed. The user then performs a throw gesture. The calling service 8 or service discovery protocol 18 on the device determines a set of available targets for the call transfer as described in more detail later. If there is determined to be only one available target, as soon as the camera detects any kind of throwing gesture, the call is moved to that target device. If there are multiple targets within the vicinity of the user, the cameras extract a directionality of the throw to determine as far as possible which device is intended by the user. Uses of multiple cameras, one in each device, each of which provides a different angle on the user, can help improve the accuracy of this.

Once a directionality is determined, location information reported from the devices can be used to determine relative positioning of target devices relative to the initiating device (the device from which the call is transferred). Location information can be reported from a GPS module on each device. When the GPS is not available (for example, on the television), the television 102d may utilise a set-up process during activation whereby the user uses their mobile phone, bringing it near the television, and then pressing a button to utilise the GPS location from the phone as a measure of the television's location. A similar procedure can be done for PC and points which lack GPS. The location information is reported to the calling service 8 to be stored at the data store 104.

Devices for “accepting” the transferred call can be associated with the user by his login, but they do not need to be. Consider a hotel room where a user has just one device (their phone) and the TV; the throw would always target the TV in the hotel room. The hotel room TV could also know its location ahead of time, and report that to the server once the user logs into his device. On “accepting” the call, the TV can be instructed to log in as described later.

In the following description which explains how the above method is implemented, the “grab” gesture of the user is referred to as a first input gesture, and the selection of the alternate device by the “throw” gesture is referred to as a second input.

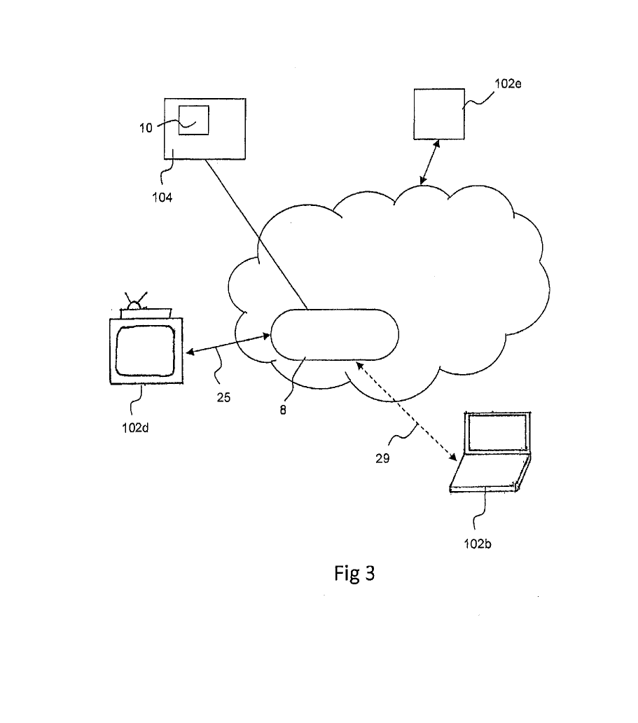

With reference now to the context illustrated in FIG. 3, the user is on a call over connection 25 to the third party 102e over calling service 8. When the user makes the first input gesture at the television 102d, it reports its GPS location to the calling service 8. To do this, the television 102d has a GPS positioning module 19 (see FIG. 4). The calling service 8 interrogates the laptop 102b and obtains its location as well. Alternatively, the laptop 102b and mobile phone 102a could report its presence on a Wifi network in common with the television 102d. Assume that the user selects the laptop 102b by the second input “throw” gesture. This is detected by the camera 40, and reported to the calling service 8. The calling service creates a new connection 29 and transfers the call from the television 102d to the laptop 102b.

In the case that the laptop 102b is not running an instance of the client 4, has for example, an alternate video client, it can nevertheless be instructed to connect to the calling service 8 by use of a token provided to it by device 102d.

Communication between the client instances and the calling service 8 is enabled by reference to the system of user IDs and sub-IDs mapped to IP addresses or other such network addresses by the data store 104. Thus the list of sub-IDs for each user allows the different client instances to be identified, and the mapping allows a client instance, server or other network element to determine the address of each terminal on which one or more other different instances is running. In this manner it is possible to establish communications between one client and another or between the client and a server or other network element for the purpose of transferring a call from one user device to the selected user device when they are managed by the same calling service.

Alternatively, communication set up may be enabled by maintaining a list of only the terminal identities rather than the corresponding client identities, the list being maintained on an accessible network element for the purpose of address look-up. For example a list of all the different terminals 102a-102d may be maintained on an element of the local home network, 105, 102a-102d, in which case only the local network addresses and terminal identities need be maintained in the list, and a system of IDs and separate sub-IDs would then not necessarily be required. The local list could be stored at each terminal 102a-102d or on a local server of the home network (not shown), and each client instance would be arranged to determine the necessary identities and addresses of the other instances' terminals by accessing the list over the local network.

In one implementation of call transfer where devices are managed by the same calling services, once the desired device has been selected as the endpoint for the call, then the transfer may be completed in a similar manner to known call forwarding techniques as described for example in U.S. application Ser. No. 12/290,232, publication no. US 2009-0136016 (the entire teachings of which are incorporated herein by reference), but with the call being transferred between different terminals of the same user based on different sub-IDs, rather than the call being transferred between different users based on different user IDs.

For the purpose of establishing which proximate devices should be determined as an alternate location to which a call may be transferred, proximity can be determined in a number of different ways. It can be based on GPS location, Bluetooth or other near field communications or other service discovery techniques such as Bonjour or SLP. Once other devices are identified, they are filtered by capability for handling the call. That is, they need to be either devices which contain a client running software connected to the same calling service, or devices (which can be instructed via Bluetooth or other communications) to log in on behalf of the user.

In one example, the client instances could be “network aware” and could be provided with an API enabled to facilitate not only the discovery of the different devices but also the easy transfer/usage of different media streams in a conversation from one end point to the next end point.

FIG. 4 is a schematic block diagram of elements of a device capable of transferring calls or receiving transferred calls. The device comprises a processor 50 and a memory 52. The processor 50 can download code from the memory 52 for execution depending on the required operation of the device. In particular, the processor 50 can execute communication client 4, service discovery protocol 18 and/or a visual motion recognition component 48 which implements gesture capture algorithms (42). The visual motion recognition component can receive data from a camera 34 (or 40) embedded in the screen, or elsewhere on the device. The camera 34 (or 40) is provided to capture images of the user's gestures to supply image data to the processor for processing in accordance with gesture capture algorithms. The device has a display screen 20 for rendering images to a user. The device also has a Bluetooth interface 58 and a Wifi interface 60. The device also includes the location determining devices 19, for example a GPS module.

This above embodiments of the present invention allow a user to be presented with a list of available user terminals 102 and to select at least one secondary terminal 102 with the most appropriate capabilities to handle a particular type of communication, for example a live video stream or file transfer. According to an embodiment of the invention, a terminal 102 such as the mobile phone 102a installed with an instance of the client application 4 is arranged to discover other such user terminals 102. The user may transfer the call to one or more of the discovered terminals 102.

The terminal 102 that is used by a user to perform the selection will be referred to as the first device. Each selected terminal will be referred to as the second device. In the case of an outgoing call the first device is preferably the initiator of a call, and in the case of an incoming call the first device is preferably the terminal used to answer the call.

The client 4 on the second device such as 102c may be of the same user as that on the first device (i.e. logged in with the same user ID), or may be another terminal 102e borrowed from a different user (logged in with a different user ID), or may be on a different protocol altogether. Either way, the first and second devices 102a-102e together form one end of the call (the “near end”) communicating with the client running on a further, third party device 102f (the “far end”) via the Internet 101 or other such packet-based network.

Each device 102 is preferably configured with a protocol 18 for resource discovery for discovering the presence of other potential secondary terminals 102a, 102e, etc. and/or for discovering the media capability of the potential secondary terminals. The list of available resources may indicate the terminal type (e.g. TV, printer) so as to render an appropriate icon such that the user can select the most appropriate device to handle the communication event. For example the user may select a TV for a video call, a stereo system for a voice call, or a Network Attached Storage (NAS) device for a file transfer.

The available resources of other terminals installed with instances of the client 4 may be discovered using a number of alternative methods, for example as follows. A user terminal 102 installed with a suitable client application 4 or suitable instance of the client application may be referred to in the following as an “enabled terminal”.

One such method is server assisted resource discovery. In one embodiment of the invention a server stores the location of each terminal having an instance of the client 4. When a user logs in, the client is arranged to provide its location and terminal type/capabilities to the server. The location could be defined as IP address, NAT or other suitable address input by the user. In this embodiment of the invention the server is arranged to return a list of proximate terminals to that of the first device in response to the primary client transmitting a “find suitable terminals” request to the server. This can be done responsive to the recognition of the “grab” gesture, or in advance.

The server could instead be replaced with a distributed database for maintaining the list, or a combination of the two may be used. In the case where the primary and secondary terminals are of the same user, i.e. running clients logged in with the same username, the system of usernames and sub-identifiers may be used to distinguish between the different instances in a similar manner to that discussed above. However, that is not essential and instead other means of listing the available terminals could be used, e.g. by listing only the terminal identity rather than the corresponding client identity.

Another possible method is common local network device discovery. In an alternative embodiment the primary client is arranged to display icons representing a set of terminals 102a, 102c, 102d enabled with the client 4 to the user that are discovered on the local network, responsive to the recognition of the “grab” gesture. Any IP enabled terminal that registers into a given network receives a unique IP address within that network. As an enabled terminal joins it will broadcast a presence message to all enabled terminals in that network announcing a given username/ID and a list of authorized users that have rights to access its capabilities. All the enabled terminals 102 that receive this message and have a common authorized user will reply back to authenticate themselves and establish a secure communication channel through which they will announce its IP address and available resources.

It will be appreciated that the above embodiments have been described only by way of example. Other variants or implementations may become apparent to a person skilled in the art given the disclosure herein. For example, the invention is not limited by any particular method of resource discovery or authorisation, and any of the above-described examples could be used, or indeed others. Further, any of the first, second and/or third aspects of the invention may be implemented either independently or in combination. Where it is referred to a server this is not necessarily intended to limit to a discrete server unit housed within a single housing or located at a single site. Further, where it is referred to an application, this is not necessarily intended to refer to a discrete, stand-alone, separately executable unit of software, but could alternatively refer to any portion of code such as a plug-in or add-on to an existing application.

It will be appreciated that the above embodiments have been described only by way of example. Other variants or implementations may become apparent to a person skilled in the art given the disclosure herein. For example, the invention is not limited by any particular method of resource discovery or authorisation, and any of the above-described examples could be used, or indeed others. Further, any of the first, second and/or third aspects of the invention may be implemented either independently or in combination. Where it is referred to a server this is not necessarily intended to limit to a discrete server unit housed within a single housing or located at a single site. Further, where it is referred to an application, this is not necessarily intended to refer to a discrete, stand-alone, separately executable unit of software, but could alternatively refer to any portion of code such as a plug-in or add-on to an existing application.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer-readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method for transferring a communication event between a remote user device and a first user device from the first user device to a second user device, comprising:
capturing with a visual motion recognition component a first input from a user of the first user device conducting the communication event, the first input being a physical gesture made by the user to indicate a desire to transfer the communication event;
detecting a set of user devices in physical proximity to the user;
capturing a second input from the user to select one of the set of devices as a second device, the second input being a second physical gesture made by the user; and
transferring the communication event to the second device.

2. A method according to claim 1, wherein the visual motion recognition component is configured to recognise the first physical gesture as a grab gesture.

3. A method according to claim 2, wherein the second physical gesture is a throw gesture.

4. A method according to claim 1, further comprising determining a direction of the second physical gesture to locate the selected device.

5. A method according to claim 1, wherein capturing the first input or the second input comprises at least the camera capturing an image of the user and supplying image data to a gesture capture algorithm executed by the usual motion recognition component.

6. A method according to claim 4, wherein determining the direction of the second gesture comprises capturing image data of the user by more than one camera.

7. A method according to claim 1, wherein detecting a set of user devices comprises controlling a list of user devices associated with the user and receiving reports of the physical locations of the user devices on the list.

8. A method according to claim 1, wherein detecting a set of user devices comprises executing a service discovery protocol to detect devices in physical proximity to the user.

9. A user device for conducting a communication event with a remote user device, the user device comprising:
a visual motion recognition component configured to capture first and second inputs from a user of the user device, the first input being a first physical gesture made by the user to indicate a desire to transfer the communication event and the second input being a second physical gesture;
means for detecting a set of user devices in physical proximity to the users;
wherein the second input from the user selects one of the set of devices as a second device; and
means for transferring the communication event to the second device.

10. A device according to claim 9, comprising means for identifying a set of devices determining the direction of the second physical gesture.

11. A device according to claim 9, comprising at least the camera for capturing an image of a user and supplying image data to a gesture capture algorithm executed by a user recognition component.

12. A device according to claim 9, comprising a processor configured to execute a communication client which is responsible for conducting the communication event and transferring the communication event to the second device.

13. A device according to claim 9, comprising a location device for providing a report with the geographical location of the device.

14. A device according to claim 13, wherein the location device is a global positioning system.

15. A computer program product comprising code embodied on a non-transitory computer-readable medium and configured so as when executed on a processor to implement the following steps:
capturing a first input from a user conducting a communication event, the first input being a physical gesture made by the user to indicate a desire to transfer the communication event;
capturing a second input from a user to select one of a set of devices in physical proximity to the user as a second device, the second input being a second physical gesture; and
transferring the communication event to the second device.

16. A computer program product according to claim 15, which when executed further implement the step of determining a direction of the second physical gesture.
